(19) United States
(12) Patent Application Publication
(10) Pub. No.: US 2009/0140653 A1
(43) Pub. Date: Jun. 4, 2009

(54) PLASMA DISPLAY PANEL

(76) Inventor: Seung-Hyun Son, Suwon-si (KR)

Correspondence Address: CHRISTIE, PARKER & HALE, LLP, PO BOX 7068, PASADENA, CA, 91109-7068, US

(21) Appl. No.: 12/323,339

(22) Filed: Nov. 25, 2008

(30) Foreign Application Priority Data
Nov. 30, 2007 (KR) 10-2007-0123807

(51) Int. Cl. H01J 17/49

(52) U.S. Cl. 313/582

(57) ABSTRACT

A plasma display panel (PDP) with an improved addressing operation at a lower voltage by reducing a distance of a discharge path of the PDP. The PDP also provides an improved structure for enhancing luminous efficiency. According to an embodiment of the present invention, the PDP includes a front substrate and a rear substrate, a plurality of first barrier ribs and second barrier ribs between the front and rear substrates to form a plurality of cells. Each of the second barrier ribs is closer to the scan electrode of a corresponding one of the cells than to the sustain electrode of the corresponding one of the cells. Address electrodes are provided on the rear substrate for performing address discharges along with the scan electrodes. Phosphor layer are respectively formed on at least a part of the unit cells. According to the embodiment, the second barrier ribs provide a shorter discharge path for performing address discharges.

### CROSS-REFERENCE TO RELATED PATENT APPLICATION

This application claims priority to and the benefit of Korean Patent Application No. 10-2007-0123807, filed on Nov. 30, 2007, in the Korean Intellectual Property Office, the disclosure of which is incorporated herein in its entirety by reference.

### BACKGROUND OF THE INVENTION

1. Field of the Invention

The present invention relates to a plasma display panel (PDP), and more particularly, to an addressing operation of a PDP.

2. Description of the Related Art

In a PDP, a plurality of discharge cells arranged in a matrix are interposed between an upper substrate and a lower substrate. The upper substrate includes scan electrodes and sustain electrodes for generating a discharge, and the lower substrate has a plurality of address electrodes. The upper substrate and the lower substrate are bonded and are facing each other, a discharge gas (e.g., predetermined discharge gas) is injected between the upper and lower substrates, and phosphors coated in the discharge cells are excited by a discharge pulse (e.g., predetermined discharge pulse) generated between discharge electrodes (that is, the scan and sustain electrodes) so as to generate visible light, thereby realizing a desired image.

In order to realize gradation (e.g., color, brightness, or gray levels) of images displayed by the PDP, a frame of an image is divided into several sub-fields having different light emissions, thereby performing a time-division operation. Each of the sub-fields is divided into a reset period to uniformly generate a discharge, an address period to select one or more discharge cells, and a sustain period to realize gradation of images according to the number of discharges. In the address period, a kind of auxiliary discharge is generated between the address electrodes and the scan electrodes, and a wall voltage is formed in the selected discharge cells so as to form an environment suitable for a sustain discharge.

In general, in the address period, a higher voltage (e.g., a higher address voltage) is required compared to that required for a sustain discharge. Reducing an input voltage (that is, the address voltage) for addressing and ensuring a voltage margin are essential for improving the driving efficiency of the PDP and for increasing discharge stability. Moreover, with the development of display devices with full-HD class resolution, the power consumed in a circuit board of the PDP is increased as the number of address electrodes allotted for the discharge cells is increased in proportion to the number of discharge cells. In addition, a high xenon (Xe) display, in which a partial pressure of Xe among the discharge gas injected into the inside of the PDP is increased, provides a high luminous efficiency but requires a relatively high address voltage for firing a discharge. Thus, in order to embody a high-efficiency display, a sufficient address voltage margin should be provided.

### SUMMARY OF THE INVENTION

Embodiments of the present invention provide a high-efficiency plasma display panel (PDP) capable of performing address discharges at a voltage lower than that of a conventional PDP by reducing a distance of a discharge path.

Embodiments of the present invention relate to improving luminous efficiency of a PDP by employing electron emission materials that react with a discharge electric field so as to supply electrons inside a discharge space.

Embodiments of the present invention also provide a high-quality, high contrast display, wherein noise brightness, such as discharge light or background light, which occurs during an address discharge is removed or reduced, except for light emission.

According to an embodiment of the present invention, there is provided a PDP. The PDP includes: a first substrate and a second substrate facing each other; a plurality of first barrier ribs on the second substrate between the first substrate and the second substrate and forming a plurality of cells; pairs of scan electrodes and sustain electrodes extending on the first substrate, and configured to generate display discharges in the plurality of cells; a plurality of second barrier ribs on the second substrate, each of the second barrier ribs being closer to the scan electrode of a corresponding one of the cells than to the sustain electrode of the corresponding one of the cells; an electron emission material layer on top surfaces of the second barrier ribs, wherein the top surfaces are adjacent to the scan electrodes; a plurality of address electrodes extending on the second substrate and crossing the scan electrodes, and configured to perform address discharges along with the scan electrodes; and a plurality of phosphor layers respectively on at least a part of the plurality of cells.

The second barrier ribs may face the scan electrodes, and form a discharge gap therebetween. Also, the second barrier ribs may have a height lower than a height of the first barrier ribs.

The PDP may further include a dielectric layer on the address electrodes, and the second barrier ribs may protrude from the dielectric layer toward the scan electrodes.

The electron emission material layer may extend in at least a part of the cell. The electron emission material layer may extend continuously along exterior surfaces of the first and second barrier ribs.

The phosphor layers may respectively be at cell regions of the plurality of cells corresponding to the sustain electrodes.

According to another embodiment of the present invention, there is provided a PDP. The PDP includes a first substrate and a second substrate facing each other; a plurality of first barrier ribs on the second substrate between the first substrate and the second substrate and forming a plurality of cells; pairs of scan electrodes and sustain electrodes extending on the first substrate and configured to generate discharges in the plurality of cells; a first dielectric layer on the pairs of scan electrodes and sustain electrodes and having grooves formed at positions corresponding to at least the scan electrodes; a plurality of second barrier ribs on the second substrate, each of the second barrier ribs being closer to the scan electrode of a corresponding one of the cells than to the sustain electrode of the corresponding one of the cells; an electron emission material layer on top surfaces of the second barrier ribs, wherein the top surfaces are adjacent to the scan electrodes; a plurality of address electrodes extending on the second substrate to cross the scan electrodes, and configured to perform address discharges along with the scan electrodes; and a plurality of phosphor layers respectively on at least a part of the plurality of cells.

The second barrier ribs may face the scan electrodes and form a discharge gap therebetween. The first and second barrier ribs may have a substantially equal height.

The PDP may further include a second dielectric layer on the address electrodes, and the second barrier ribs may protrude from the second dielectric layer toward the scan electrodes.

The electron emission material layer may extend in at least a part of the cell. Also, the electron emission material layer may extend continuously along exterior surfaces of the first and second barrier ribs.

The phosphor layers respectively may be on cell regions of the plurality of cells corresponding to the sustain electrodes.

### BRIEF DESCRIPTION OF THE DRAWINGS

The above and other features and aspects of the present invention will become more apparent by describing in detail exemplary embodiments thereof with reference to the attached drawings in which:

FIG. 1 is a partial exploded perspective view illustrating a plasma display panel (PDP) according to a first embodiment of the present invention;

FIG. 2 is a vertical cross-sectional view of the PDP of FIG. 1, taken along the line II-II;

FIG. 3 is a perspective view illustrating the arrangement of the components of the PDP illustrated FIG. 1;

FIG. 4 is a vertical cross-sectional view of a PDP according to a second embodiment of the present invention;

FIG. 5 is a vertical cross-sectional view of a PDP according to a third embodiment of the present invention;

FIG. 6 is a perspective view illustrating a continuous coating process for forming an electron emission material layer illustrated in FIG. 5;

FIG. 7 is a partial exploded perspective view of a PDP according to a fourth embodiment of the present invention;

FIG. 8 is a vertical cross-sectional view of the PDP of FIG. 7, taken along the line VIII-VIII;

FIG. 9 is a vertical cross-sectional view of a PDP according to a fifth embodiment of the present invention;

FIG. 10 is a drawing illustrating a simulation result obtained by numerically analyzing an address discharge phenomenon; and

FIG. 11 is a drawing illustrating a result obtained by measuring address voltage margins in a conventional PDP and a PDP according to the embodiments of the present invention.

### DETAILED DESCRIPTION OF EXEMPLARY EMBODIMENTS

Hereinafter, the present invention will now be described more fully with reference to the accompanying drawings, in which exemplary embodiments of the present invention are shown.

### First Embodiment

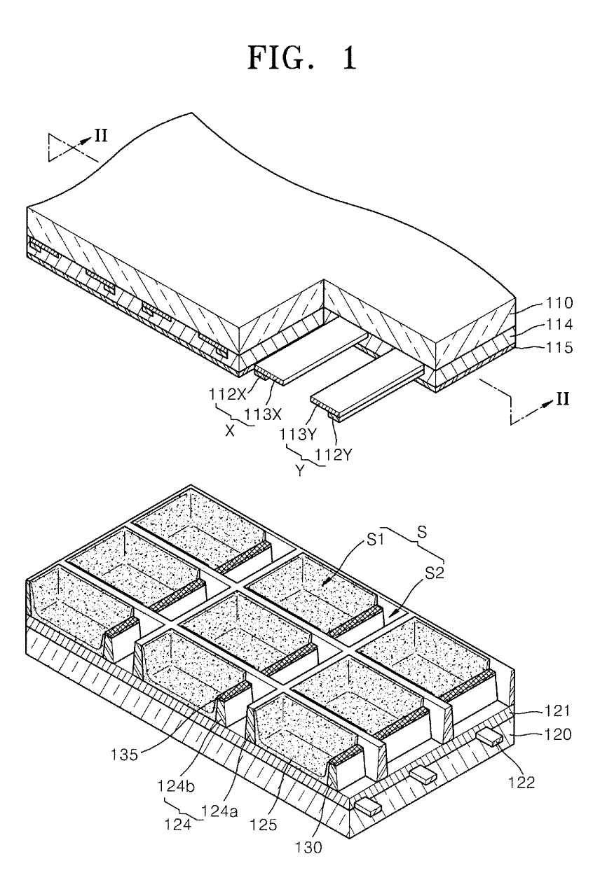

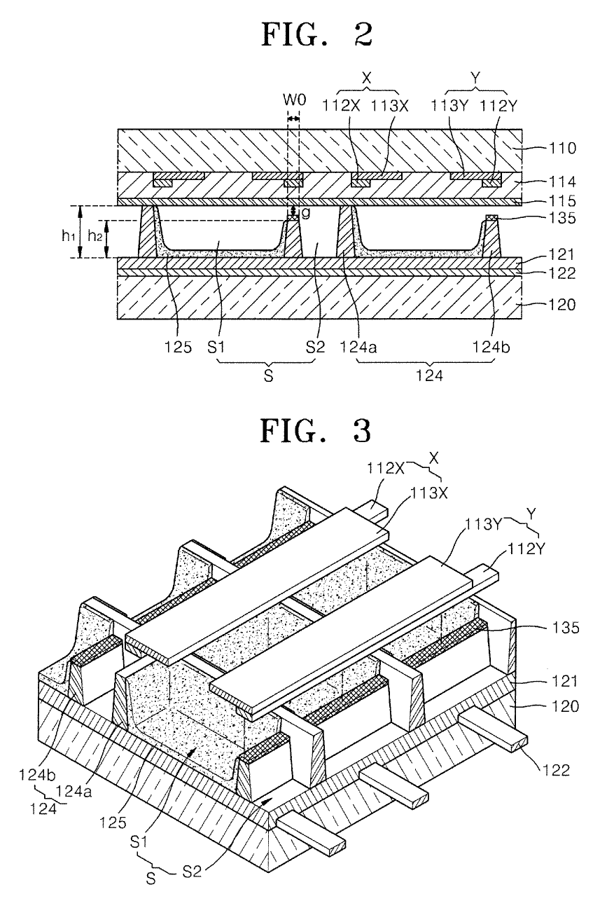

FIG. 1 is a partial exploded perspective view illustrating a PDP according to a first embodiment of the present invention. FIG. 2 is a vertical cross-sectional view of the PDP of FIG. 1, taken along the line II-II. FIG. 3 is a perspective view illustrating the arrangement of the components of the PDP illustrated in FIG. 1. The PDP of FIG. 1 includes a front substrate 110 and a rear substrate 120, which are separated from and face each other, and a plurality of barrier ribs 124 partitioning a space between the front substrate 110 and the rear substrate 120 into a plurality of cells S. Each of the unit cells S is a smallest light-emitting unit in which a pair of sustain electrodes X and Y generate a display discharge and in which an address electrode 122 is extended to cross the pair of sustain electrodes X and Y, and the cells S are defined by the barrier ribs 124, thereby realizing a display. Each of the cells S constitutes an independent light emitting area. Corresponding to a cell S among the plurality of cells S, the sustain electrodes X and Y represent respectively a sustain electrode X and a scan electrode Y. Each of the sustain electrodes X and Y may respectively include bus electrodes 112X and 112Y, which constitute a power supply line, and transparent electrodes 113X and 113Y, which are formed of a conductive transparent material and extend to cross the cell S, and respectively form an electrical contact with the bus electrodes 112X and 112Y. The pair of sustain electrodes X and Y may be covered with a front dielectric layer 114 so as not to be directly exposed to a discharge environment, and thus are protected from direct collision with charged particles participating in a discharge. The front dielectric layer 114 may be covered with a protective layer 115 including, for example, an MgO thin film. The protective layer 115 protects the front dielectric layer 114 and induces emission of secondary electrons, thereby serving to activate the discharge.

With respect to each cell S, the address electrode 122 is disposed on the rear substrate 120. The address electrode 122 performs an address discharge along with the scan electrode Y, and the address electrode 122 and the scan electrode Y are disposed to cross each in the cell S. Here, the address discharge represents a kind of auxiliary discharge that supports a display discharge by accumulating priming particles in each of the cells S before a display discharge occurs. A discharge voltage applied between the scan electrode Y and the address electrode 122 is focused in the vicinity of a discharge gap g between the front dielectric layer 114 that covers the scan electrode Y and the barrier ribs 124 that are on the address electrode 122. A firing discharge may occur via the discharge gap g that provides a shortest discharge path. This is because a dielectric constant of a discharge gas filled inside the cell S is higher than a dielectric constant of the barrier ribs 124. The address electrode 122 may be covered with a rear dielectric layer 121 formed on the rear substrate 120, and the barrier ribs 124 may be formed on a flat surface of the rear dielectric layer 121.

The barrier ribs 124 are formed between the front substrate 110 and the rear substrate 120, and have a plurality of first barrier rib units 124a each formed to have a first height h1 and a plurality of second barrier rib units 124b each formed to have a second height h2. The first height h1 of the first barrier rib units 124a may correspond to a height that can seal the cells S, thereby preventing any optical and electrical crosstalk between the cells S that are adjacent to each other. The term “seal” does not require that the cells S are hermetically sealed, and a gap having a minute size within a tolerance limit may exist on the first barrier rib units 124a. Corresponding to a cell S among the plurality of cells S, the second barrier rib unit 124b, having the second height h2 that is lower than that of the first barrier rib unit 124a, provides the discharge gap g between the second barrier rib unit 124b and the scan electrode Y, and provides a flow path for priming particles created from the address discharge. The second barrier rib units 124b and the first barrier rib units 124a may be integratedly formed by a single process that patterns a paste to form the barrier ribs 124. Thus, the first and second barrier rib units 124a and 124b may be formed together, without the need of an additional process, as compared to conventional technology. Also, the second barrier rib units 124b may be formed with dielectric materials such as, but not limited to, PbO, B₂O₃, SiO₂, TiO₂, and the like. The second barrier rib units 124b may be formed with a material having a sufficient dielectric constant so that the address electrodes 122 and the scan electrodes Y may generate discharges via the second barrier rib units 124b. In the conventional PDP structure, an auxiliary discharge between a scan electrode and an address electrode is performed via a discharge path having a long distance corresponding to a cell height. However, in the first embodiment of the present invention having a structure in which the second barrier rib units 124b are formed to have the second height h2 so as to face the scan electrodes Y, a discharge path between each of the scan electrodes Y and a corresponding one of the address electrodes 122 is reduced to the discharge gap g having the minute size. Therefore, the PDP structure (shown in FIGS. 1-3) may generate the same amount of priming particles at an address voltage that is lower than that of the conventional PDP structure, thereby reducing power consumption, and the PDP structure may generate more priming particles at a same address voltage as that of the conventional PDP structure, thereby enhancing luminous efficiency. Also, in the conventional PDP structure, a phosphor layer is positioned on the discharge path between the scan electrode and the address electrode. Thus, charged particles participating in the address discharge directly bump against the phosphor layer resulting in degradation of the phosphor layer, brightness being gradually decreased, and a permanent latent image being incurred, thereby deteriorating image quality. Some embodiments of the present invention exclude the phosphor layer from the discharge path for the address discharge, thereby solving the aforementioned problems of degradation of the phosphor layer and deterioration of image quality.

When the second barrier rib units 124b are formed, each of the cells S is partitioned into a main discharge space S1 and an auxiliary discharge space S2. For convenience of description, the main discharge space S1 and the auxiliary discharge space S2 are so divided according to their respective sizes of a discharge volume, and are not functionally separated from each other. For example, the display discharge may occur not only in the main discharge space S1 but also in the auxiliary discharge space S2, in the form of a long gap discharge. The main discharge space S1 and the auxiliary discharge space S2 form a connected space via the discharge gap g formed on the second barrier rib unit 124b so that priming particles generated in the auxiliary discharge space S2 during the address discharge are naturally diffused to the main discharge space S1 via the discharge gap g so as to participate in the display discharge. The address voltage applied between the scan electrode Y and the address electrode 122 may generate more discharge activities in the auxiliary discharge space S2 rather than in the main discharge space S1 which experiences a covering effect due to a phosphor layer 125 formed therein. Thus, the auxiliary discharge space S2 should provide a volume large enough to hold a discharge gas for supplying sufficient priming particles from the address discharge. For example, the volume of the auxiliary discharge space S2 may be varied by adjusting a position of the second barrier rib unit 124b in the cell S.

The address discharge may occur via the discharge gap g between a top surface of the second barrier rib unit 124b and the scan electrode Y that are facing each other. Here, in order to reduce the discharge path, with respect to each cell S, the scan electrode Y and the second barrier rib unit 124b may be disposed to overlap each other, and in the first embodiment, the scan electrode Y and the second barrier rib unit 124b are disposed so as to form an overlapping area with a width WO between the scan electrode Y and the second barrier rib unit 124b. Also, an electron emission material layer 135 may be formed on the top surface of the second barrier rib unit 124b constituting a discharge surface. The electron emission material layer 135 is comprised of materials which react with a discharge field converging in the vicinity of the discharge gap g so as to induce electron emission. Examples of such materials may be, but not limited to, MgO nano powder, Sr—CaO thin film, carbon powder, metal powder, MgO paste, ZnO, BN, MIS nano powder, OPS nano powder, ACE, CEL, etc. The electron emission material layer 135 supplies secondary electrons inside a discharge space according to a field emission principle, apart from charged particles generated from an ionization process due to a discharge, thereby activating and accelerating firing of a discharge.

The address discharge that mainly occurs in the auxiliary discharge space S2 serves to supply the priming particles for participating in the display discharge and does not directly provide light emission. When discharge light that unavoidably occurs due to the address discharge is leaked together with the light emission, the discharge light creates blurry noise brightness around an emitting pixel, thereby deteriorating a resolution of a display. Thus, in order to block or reduce the discharge light generated in the auxiliary discharge space S2, formation of a black stripe on the auxiliary discharge space S2 may be considered. However, the bus electrode 112Y, which is a part of the scan electrode Y, generally may be made of a metallic conductive material, and thus, may directly block or reduce the light. Hence, forming the black stripe is not necessarily required. In this regard, according to the first embodiment of the present invention, the main discharge space S1 for the display charge and the auxiliary discharge space S2 for the address charge are located at different positions, and thus, a technical method capable of blocking the discharge light may be easily provided, and applying the black stripe to a selected position may be one of a plurality of options for blocking or reducing the discharge light generated in the auxiliary discharge space S2. However, in the conventional technology, the display discharge and the address discharge are generated at a same position, and thus, blocking the discharge light is actually impossible or very difficult so that display quality deteriorates. In particular, in the conventional technology, visible light generated by phosphor activated by the address discharge creates background light, which deteriorates a contrast characteristic of a PDP. The first embodiment of the present invention structurally excludes the phosphor from the auxiliary discharge space S2 in which the address discharge is focused, and thus, the background light occurring along with light emission due to phosphor activation during a conventional address discharge can be removed or reduced. Thus a HD display having high contrast can be realized.

The phosphor layer 125 is formed in at least a part of the cell S. That is, the phosphor layer 125 may be formed in the part of the cell S, or may be formed inside the whole cell S. However, in the cell S, the phosphor layer 125 may be formed on a cell region in which the sustain electrode X is disposed, defined by the second barrier rib unit 124b, that is, the phosphor layer 125 may be formed on an inner wall of the main discharge space S1 in which the display discharge between the sustain electrode X and the scan electrode Y is focused. Within a cell S, the phosphor layer 125 may be formed from side surfaces of the first and second barrier rib units 124a and 124b, wherein the side surfaces contact the main discharge space S1, to the rear dielectric layer 121 between the side surfaces. The phosphor layer 125 interacts with ultraviolet light generated from the display discharge, thereby generating visible light of different colors. For example, by coating red (R), green (G), and blue (B) phosphors in the main discharge spaces S1, each main discharge space S1 or each cell S corresponds to R, G, or B subpixels. In the first embodiment of the present invention, the phosphor layer 125 is not formed inside the auxiliary discharge space S2, and the reason therefor is described as follows. Different phosphors including different materials have different electrical properties which may affect a sensitive discharge environment. For example, a surface potential of the G phosphor, which is based on zinc silicate such as Zn2SiO4:Mn, has a tendency to be negatively charged, while the R and B phosphors such as Y(V,P)O4:Eu or BAM:Eu, etc., have a tendency to be positively charged. Thus, in order to prevent the phosphors from causing a discharge interference and in order to form a uniform discharge environment, the phosphors may be separated from a discharge path for the address discharge and may not be coated inside the auxiliary discharge space S2. In a conventional PDP, the phosphors are directly exposed to the address discharge, and thus, even when a uniform address voltage is applied to discharge spaces, a voltage actually applied inside the discharge spaces is affected differently according to an electrical property of the phosphors. That is, the G phosphor (which has a tendency to be negatively charged) serves to decrease the address voltage while the R and B phosphors (which have a tendency to be positively charged) serve to increase the address voltage, and therefore, the voltages applied inside the discharge spaces varies even though the address voltage applied to the discharge spaces is uniform. As a result, the address voltage margin is reduced. According to the first embodiment in which the phosphor layer 125 is excluded from the auxiliary discharge space S2 in which the address discharge mainly occurs, the address voltage applied from outside of the PDP may be uniformly transferred to each auxiliary discharge space S2, without being distorted by a unique electrical property of the phosphor layer 125, and thus, the address voltage margin may be greatly increased. Compared to the conventional technology, the same discharge effect may be obtained with a lower address voltage, and also, when the same address voltage is used, more priming particles may be stored and a discharge intensity in the subsequent display discharge may be increased.

The discharge gas is injected inside the cell S including the main discharge space S1 and the auxiliary discharge space S2 to enable the generation of ultraviolet light. A multi-component gas, in which xenon (Xe), krypton (Kr), helium (He), neon (Ne), etc., capable of emitting suitable ultraviolet light by discharge excitation are mixed in a volume fraction (e.g., predetermined volume fraction), may be used as the discharge gas. A conventional method of using a high Xe discharge gas, in which an Xe mixture proportion is increased, can provide a display with high luminous efficiency. However, the conventional method requires a high firing voltage, thereby causing an increase in the amount of power consumed, circuit re-design for increasing nominal power, etc. Considering the aforementioned problems, the use of the conventional method is limited. According to the first embodiment of the present invention in which the address voltage margin is increased, sufficient priming particles for performing the discharge may be obtained, so that a high Xe PDP having an increased luminous efficiency can be realized.

### Second Embodiment

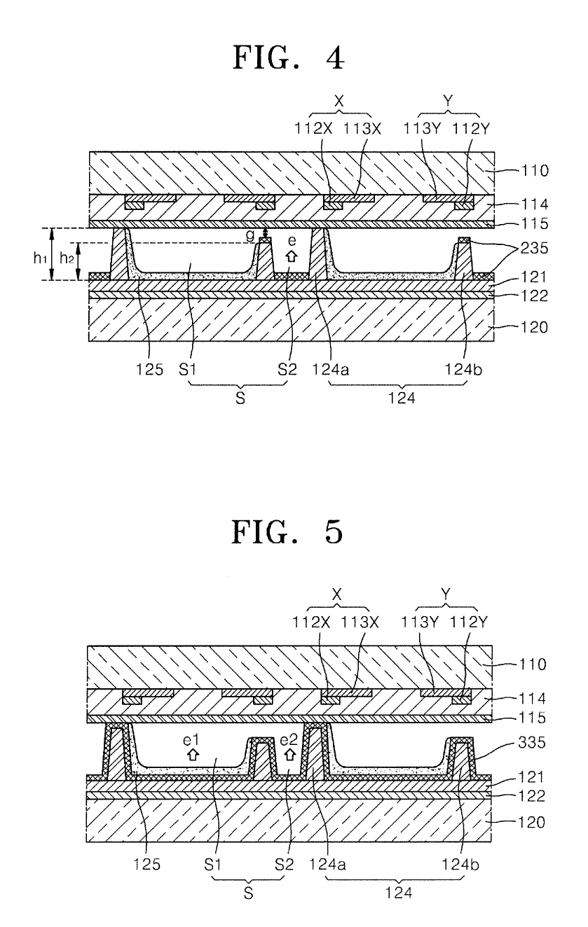

FIG. 4 is a vertical cross-sectional view of a PDP according to a second embodiment of the present invention. Referring to FIG. 4, first and second barrier rib units 124a and 124b are interposed between a front substrate 110 and a rear substrate 120 which face each other. The second barrier rib unit 124b having a second height h2 (e.g., a predetermined height) is disposed to face a scan electrode Y, thereby providing a discharge gap g therebetween. The second embodiment is different from the first embodiment, in that an electron emission material layer 235 is formed on not only a top surface of the second barrier rib unit 124b but is also extendedly formed inside an auxiliary discharge space S2. For example, the electron emission material layer 235 may be formed on the top surface of the second barrier rib unit 124b and on a region of a rear dielectric layer 121 between the first barrier rib unit 124a and the second barrier rib unit 124b which contact the auxiliary discharge space S2. The electron emission material layer 235 supplies secondary electrons —e— generated by an electric field converged inside the auxiliary discharge space S2 apart from electrons generated by an ionization process, thereby creating an environment suitable for an address discharge and causing the focused address discharge to occur mainly in the auxiliary discharge space S2 rather than in a main discharge space S1.

### Third Embodiment

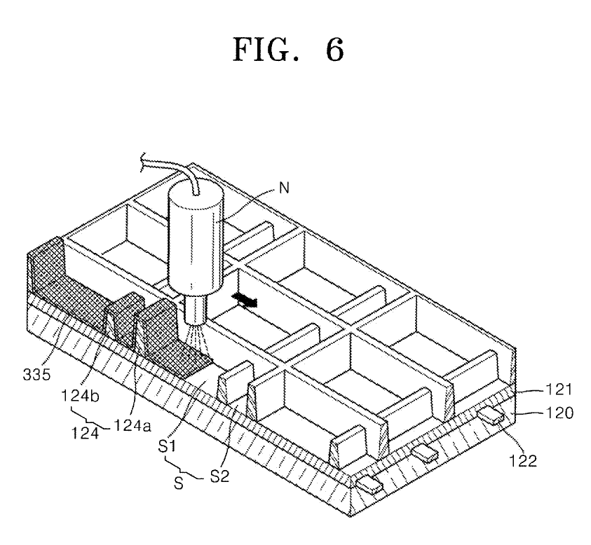

FIG. 5 is a vertical cross-sectional view of a PDP according to a third embodiment of the present invention. Referring to FIG. 5, a first barrier rib unit 124a and a second barrier rib unit 124b, which have different heights, are disposed between a front substrate 110 and a rear substrate 120 which are disposed to face each other. The second barrier rib unit 124b is formed at a position corresponding to a scan electrode Y, thereby providing a discharge gap g therebetween. In the third embodiment, an electron emission material layer 335 is formed not only on a top surface of the second barrier rib unit 124b but also on the first and second barrier rib units 124a and 124b and a rear dielectric layer 121 between the first and second barrier rib units 124a and 124b. As illustrated in FIG. 6, the electron emission material layer 335 may be formed by a continuous coating process by moving an injection nozzle N from one end of a substrate panel to another end, while coating pasted electron emission materials on the substrate panel. For example, in order to intermittently coat the electron emission material layer 335 only on the top surface of the second barrier rib unit 124b according to a direction of movement of the injection nozzle N, a complicated circuit configuration is required to accurately control a coating start point and a coating end point of the injection nozzle N while it is moving at a constant speed across the substrate panel. Also, the electron emission material layer 335 may not be sufficiently formed on a barrier rib due to a control error. Therefore, by forming the electron emission material layer 335 by employing the continuous coating process, the complicated circuit configuration is not required and thus, a process time may be reduced and a yield rate of production may be increased. A phosphor layer 125 may be formed on the electron emission material layer 335 which covers the same region and is previously formed. Here, a portion of the emission material layer 335 covered with the phosphor layer 125 may supply secondary electrons —e1— to a main discharge space S1 via gaps between phosphor particles, thereby performing a display discharge mainly therein. Another portion of the electron emission material layer 335 formed inside an auxiliary discharge space S2 is directly exposed to a discharge environment, without being covered by the phosphor layer 125, and supplies secondary electrons e2 inside the auxiliary discharge space S2, thereby performing an address discharge mainly therein.

### Fourth Embodiment

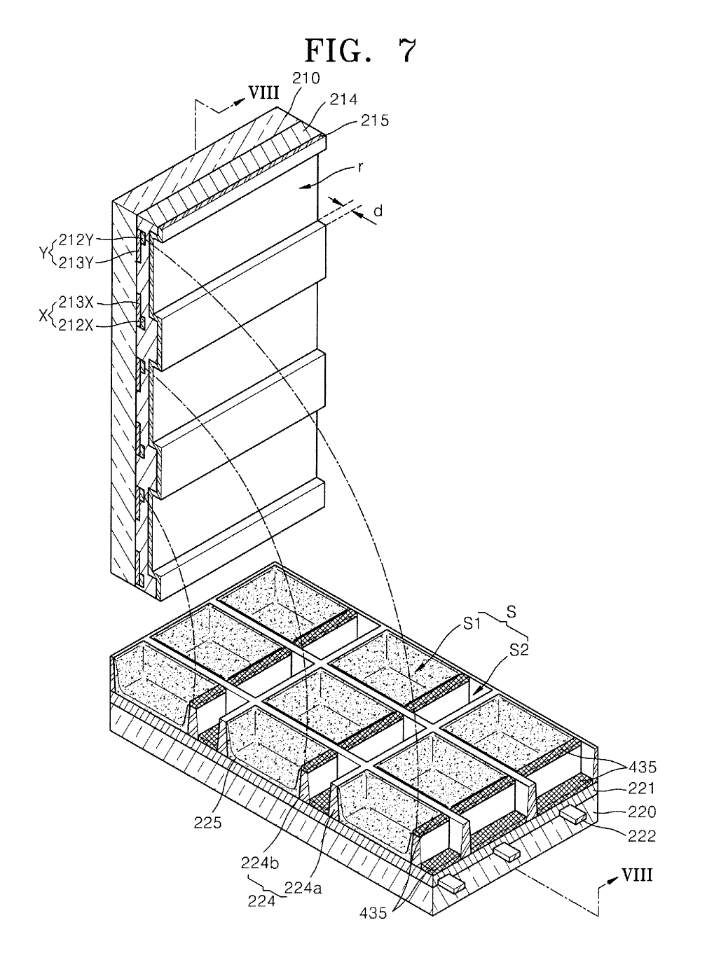

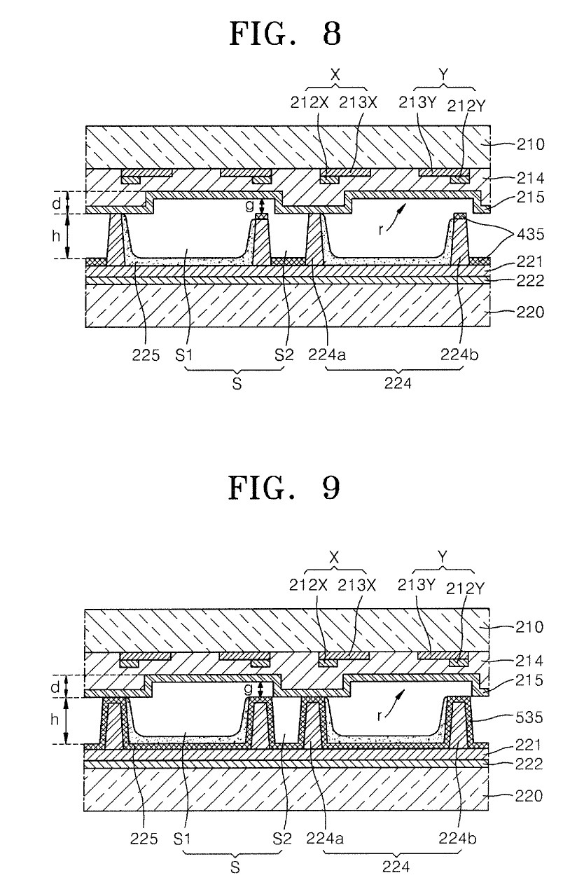

FIG. 7 is a partial exploded perspective view of a PDP according to a fourth embodiment of the present invention. FIG. 8 is a vertical cross-sectional view of the PDP of FIG. 7, taken along the line VIII-VIII. Referring to FIGS. 7 and 8, a first barrier rib unit 224a and a second barrier rib unit 224b are interposed between a front substrate 210 and a rear substrate 220 which face each other with a gap (e.g., a predetermined gap) therebetween. The second barrier rib unit 224b is formed at a position corresponding to a scan electrode Y. The second barrier rib unit 224b facing the scan electrode Y provides an opposing discharge surface, thereby forming a discharge gap g therebetween. Each cell S corresponds to a pair of scan electrode Y and sustain electrode X and an address electrode 222, and each cell S is partitioned by the first barrier rib unit 224a, wherein the pair of scan electrode Y and sustain electrode X generate a display discharge, and wherein the address electrode 222 is extended to cross the scan electrode Y so as to cause an address discharge along with the scan electrode Y.

The sustain electrode X and the scan electrode Y respectively include bus electrodes 212X and 212Y and transparent electrodes 213X and 213Y, and may be covered with a front dielectric layer 214. A protective layer 215 may be further formed on the front dielectric layer 214. Also, a rear dielectric layer 221 for covering the address electrode 222 is formed on the rear substrate 220.

In the fourth embodiment, the first and second barrier rib units 224a and 224b are formed to have an equal height h. Also, in order to form the discharge gap g, a groove r having a depth d (e.g., a predetermined depth) is formed in the front dielectric layer 214 that covers the scan electrode Y. The groove r is formed at a position corresponding to at least the scan electrode Y, and may be extended to the sustain electrode X, as illustrated in FIG. 8. Priming particles stored in an auxiliary discharge space S2 due to an address discharge effect are diffused to a main discharge space S1 via the discharge gap g, thereby participating in the display discharge. Also, forming an electron emission material layer 435 on the second barrier rib unit 224b can accelerate the occurrence of a discharge and help activating the discharge at an addressing stage. The electron emission material layer 435 reacts with a high electric field converged in the vicinity of the discharge gap g, thereby emitting secondary electrons. The electron emission material layer 435 may include materials having a electron emission characteristic, such as, but not limited to, MgO nano powder, Sr—CaO thin film, carbon powder, metal powder, MgO paste, ZnO, BN, MIS nano powder, OPS nano powder, ACE, CEL, etc. Also, the electron emission material layer 435 may be extended to the auxiliary discharge space S2 so as to be formed on a region of the rear dielectric layer 221 between the first and second barrier rib units 224a and 224b that define the auxiliary discharge space S2. The electron emission material layer 435 supplies the secondary electrons inside the auxiliary discharge space S2, thereby performing the discharge, and therefore, the address discharge is focused inside the auxiliary discharge space S2

### Fifth Embodiment

FIG. 9 is a vertical cross-sectional view of a PDP according to a fifth embodiment of the present invention. Referring to FIG. 9, a first barrier rib unit 224a and a second barrier rib unit 224b are formed having an equal height h between a front substrate 210 and a rear substrate 220. A groove r having a depth d (e.g., a predetermined depth) is formed at a position in a front dielectric layer 214 and corresponding to a scan electrode Y, thereby providing a discharge gap g between the front dielectric layer 214 and the second barrier rib unit 224b. In the fifth embodiment, while the groove r having the depth d is formed in the front dielectric layer 214, an electron emission material layer 535 is concurrently formed on the first and second barrier rib units 224a and 224b, and on a front dielectric layer 221 therebetween. Such an electron emission material layer 535 may be formed by continuously moving an injection nozzle N from one end of a substrate panel to another end while coating pasted electron emission materials on the substrate panel (refer to FIG. 6). By applying a continuous coating process, the coating process can be easily controlled, a process time is reduced, and a yield rate of production is increased, so that competitiveness of a product including the PDP may be increased through cost reduction. Both the electron emission material layer 535 and a phosphor layer 225 are coated in a main discharge space S1, and according to a coating order, the phosphor layer 225 may be formed on the electron emission material layer 535. Also, the phosphor layer 225 may be formed only in the main discharge space S1. By excluding the phosphor layer 225 from an auxiliary discharge space S2 in which an address discharge mainly occurs, a discharge interference that occurs due to a unique electrical property of phosphor of the phosphor layer 225 may be removed or reduced.

### Simulation and Measuring Result

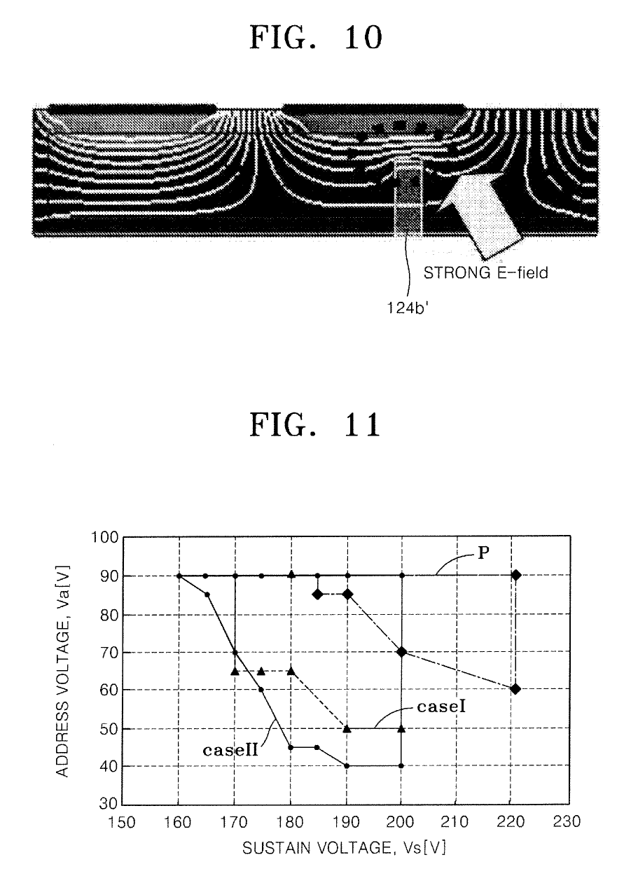

FIG. 10 is a drawing illustrating a simulation result obtained by numerically analyzing an address discharge phenomenon. FIG. 10 illustrates an electric field distribution by equi-potential lines inside a discharge space at an addressing stage, and it can be seen that a strong electric field converges on a second barrier rib 124b′. Based on such a strong electric field, an address discharge may be caused via a discharge gap on the second barrier rib 124b′, and a discharge may be focused in the vicinity of the discharge gap.

An effect of the embodiments of the present invention for increasing an address voltage margin can be seen in an experiment result illustrated in FIG. 11. In FIG. 11, a horizontal axis represents a sustain voltage Vs for a display discharge, and a vertical axis represents an address voltage Va for an address discharge. The display discharge may be generated by properly mixing the sustain voltage Vs and the address voltage Va. Profiles P, case I, and case II, which are respectively denoted by using a closed polygon, define a range of voltage capable of generating the display charge, and the inside of the closed polygon represents an operating region in which a discharge may occur. Here, the profile P indicates the operating region of a conventional PDP, and the profiles case I and case II indicate the operating regions measured in a case I and a case II of the embodiments of the present invention according to selection of electron emission materials. Referring to FIG. 11, the address voltage margin of the conventional PDP corresponding to profile P is measured at approximately 30V, and the address voltage margin of the embodiments of the present invention are measured at 40V and 50V respectively in case I and case II, a significant increase compared to the conventional PDP. In the experiment, a three-electrode surface discharge structure having a uniform barrier rib height and having a non-partitioned unit cell is used for the conventional PDP. A PDP structure illustrated in FIG. 1 having the first and second barrier rib units 124a and 124b is used for generating the results of case I and case II. Here, a CEL thin film and an MgO thin film, each having a crystal size of 200 nm, are used as an electron emission material layer 135 for case I and case 11, respectively.

As described above, in a PDP according to the embodiments of the present invention, the barrier rib unit is arranged so as to face the scan electrode to provide a discharge gap therebetween in which an address electric field converges. Thus, a discharge path is reduced to a minute discharge gap size, so that a sufficient addressing effect can be obtained with a lower voltage, compared to a conventional PDP structure. Accordingly, the address voltage margin is increased, and discharge stability and a sufficient discharge effect are obtained with a lower address voltage, so that a high quality Xe plasma display with enhanced luminous efficiency can be obtained. Thus, the requirement for reducing the amount of power consumed in an HD display corresponding to a full-HD resolution device can be satisfied. In some embodiments according to the present invention, the electron emission material layer is applied inside the discharge space in which the discharge electric field converges, and the electron emission material layer supplies the secondary electrons by employing a field emission principle, thereby activating a discharge and enhancing luminous efficiency.

Also, in the embodiments of the present invention, the discharge light or the background light is removed or reduced during the address discharge, so that an HD display according to the embodiments of the present invention can have high contrast.

While the present invention has been particularly shown and described with reference to exemplary embodiments thereof, it will be understood by those of ordinary skill in the art that various changes in form and details may be made therein without departing from the spirit and scope of the present invention as defined by the following claims and their equivalents thereof.

What is claimed is:

1. A plasma display panel (PDP), comprising:
a first substrate and a second substrate facing each other;
a plurality of first barrier ribs on the second substrate between the first substrate and the second substrate and forming a plurality of cells;
pairs of scan electrodes and sustain electrodes extending on the first substrate, and configured to generate display discharges in the plurality of cells;
a plurality of second barrier ribs on the second substrate, each of the second barrier ribs being closer to the scan electrode of a corresponding one of the cells than to the sustain electrode of the corresponding one of the cells;
an electron emission material layer on top surfaces of the second barrier ribs, wherein the top surfaces are adjacent to the scan electrodes;
a plurality of address electrodes extending on the second substrate and crossing the scan electrodes, and configured to perform address discharges along with the scan electrodes; and
a plurality of phosphor layers respectively on at least a part of the plurality of cells.

2. The PDP of claim 1, wherein the second barrier ribs face the scan electrodes and form a discharge gap therebetween.

3. The PDP of claim 1, wherein the second barrier ribs have a height lower than a height of the first barrier ribs.

4. The PDP of claim 1, further comprising a dielectric layer on the address electrodes,
wherein the second barrier ribs protrude from the dielectric layer toward the scan electrodes.

5. The PDP of claim 1, wherein the electron emission material layer extends in at least a part of the cell.

6. The PDP of claim 5, wherein the electron emission material layer continuously extends along exterior surfaces of the first barrier ribs and the second barrier ribs.

7. The PDP of claim 1, wherein the plurality of phosphor layers are respectively at cell regions of the plurality of cells corresponding to the sustain electrodes.

8. A plasma display panel (PDP), comprising:
a first substrate and a second substrate facing each other;
a plurality of first barrier ribs on the second substrate between the first substrate and the second substrate and forming a plurality of cells;
pairs of scan electrodes and sustain electrodes extending on the first substrate, and configured to generate discharges in the plurality of cells;
a first dielectric layer covering the pairs of scan electrodes and sustain electrodes and having grooves at positions corresponding to at least the scan electrodes;
a plurality of second barrier ribs on the second substrate, each of the second barrier ribs being closer to the scan electrode of a corresponding one of the cells than to the sustain electrode of the corresponding one of the cells;
an electron emission material layer on top surfaces of the second barrier ribs, wherein the top surfaces are adjacent to the scan electrodes;
a plurality of address electrodes extending on the second substrate and crossing the scan electrodes, and configured to perform address discharges along with the scan electrodes; and
a plurality of phosphor layers respectively on at least a part of the plurality of cells.

9. The PDP of claim 8, wherein the second barrier ribs face the scan electrodes and form a discharge gap therebetween.

10. The PDP of claim 8, wherein the first barrier ribs and the second barrier ribs have a substantially equal height.

11. The PDP of claim 8, further comprising a second dielectric layer covering the address electrodes,
wherein the second barrier ribs protrude from the second dielectric layer toward the scan electrodes.

12. The PDP of claim 8, wherein the electron emission material layer extends in at least a part of the cell.

13. The PDP of claim 12, wherein the electron emission material layer continuously extends along exterior surfaces of the first barrier ribs and the second barrier ribs.

14. The PDP of claim 8, wherein the plurality of phosphor layers are respectively on cell regions of the plurality of cells corresponding to the sustain electrodes.
